(19) United States
(12) Patent Application Publication
(10) Pub. No.: US 2006/0224718 A1
(43) Pub. Date: Oct. 5, 2006

(54) Content providing system and information collecting device and program

(75) Inventors: Yuji Sato, Nagoya-shi (JP); Masatoshi Kokubo, Aichi-ken (JP); Satoru Yanagi, Nagoya-shi (JP); Kazuma Aoki, Kasugai-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Brother Kogyo Kabushiki Kaisha, Nagoya-shi (JP)

(21) Appl. No.: 11/391,488

(22) Filed: Mar. 29, 2006

(30) Foreign Application Priority Data
Mar. 29, 2005 (JP) 2005-094937

(51) Int. Cl. G06F 15/173

(52) U.S. Cl. 709/223

(57) ABSTRACT

A content providing system includes an information collecting device including a content collecting unit and a content providing unit, a plurality of relaying devices each configured to relay transmission of the collected contents provided by the content providing unit, and a terminal device connected to at least one relaying device so as to communicate therewith, the contents collected by the content collecting unit being transmitted by the content providing unit to the terminal device via the at least one relaying device. The content collecting unit collects contents in accordance with a predetermined collecting condition. Further, the content providing unit transmits the contents to the relaying devices, each content transmitted to the relaying device being relayed to the terminal device connected to the relaying device, a type of content transmitted to each relaying device being determined in accordance with a location of the relaying device.

### CROSS-REFERENCE TO RELATED APPLICATION

This application claims priority from Japanese Patent Application No. 2005-094937, filed on Mar. 29, 2005, the entire subject matter of the application is incorporated herein by reference.

### BACKGROUND

1. Technical Field

The present invention relates to a content providing system configured to collect contents through a network to a terminal device.

2. Description of Related Art

Recently, various kinds of techniques have been suggested for providing contents by collecting contents through a network and providing the predetermined contents to respective terminal devices.

An example of such a content providing system is disclosed in Japanese Patent Provisional Publication No. P2003-85439A (hereinafter, simply referred to as '439 publication). Specifically, according to the '439 publication, by which ones of a plurality of contents reproducing terminal devices (e.g., monitors), a content (e.g., advertising information) provided by an information collecting device (e.g., a central server) is to be reproduced is set in accordance with a command from a user's terminal device which can perform data communication with the information collecting device. Then, based on the settings, contents are transmitted from the information collecting device to the terminal device for reproduction.

According to the above-described technique, the content to be reproduced is determined by the command from the terminal device of the user, and the content is transmitted to the user's terminal device. Therefore, when the terminal device is moved or changed, the command issued by the user's terminal device requires new settings. Therefore, it is relatively difficult to change the terminal device easily.

### SUMMARY OF THE INVENTION

Aspects of the invention are advantageous in that there is provided an improved technique which enables change of settings of the terminal device easily when the network device collects contents via the network and transmits the same to the terminal device.

### BRIEF DESCRIPTION OF THE ACCOMPANYING DRAWINGS

FIG. 1 is a block diagram showing a system configuration of a content providing system according to aspects of a first embodiment of the invention.

FIG. 2 is a block diagram showing a configuration of an information collecting device according to aspects of the first embodiment of the invention.

FIG. 3 is a flowchart illustrating a new terminal registration procedure according to aspects of the invention.

FIGS. 4A-4E show examples of data structures of terminal devices according to aspects of the first embodiment.

FIGS. 5A-5C show examples of various tables according to aspects of the first embodiment.

FIG. 6 is a flowchart illustrating a terminal deleting procedure according to aspects of the invention.

FIG. 7 is a flowchart illustrating an information collecting procedure according to aspects of the invention.

FIG. 8 shows an example of a data structure of a keyword table according to aspects of the invention.

FIG. 9 is a flowchart illustrating a category list creating procedure according to aspects of the invention.

FIG. 10 is a flowchart illustrating an information delivery procedure according to aspects of the invention.

FIG. 11 is a block diagram of a content providing system according to aspects of a second embodiment.

FIGS. 12A-12F are data structures of terminal information according to aspects of the second embodiment.

FIGS. 13A-13C show data structure of various tables according to aspects of the second embodiment.

### DETAILED DESCRIPTION

General Overview

It is noted that various connections are set forth between elements in the following description. It is noted that these connections in general and unless specified otherwise, may be direct or indirect and that this specification is not intended to be limiting in this respect. Aspects of the invention may be implemented in computer software as programs storable on computer-readable media including but not limited to RAMs, ROMs, flash memory, EEPROMs, CD-media, DVD-media, temporary storage, hard disk drives, floppy drives, permanent storage, and the like.

According to aspects of the invention, there is provided a content providing system, which is provided with an information collecting device including a content collecting unit and a content providing unit, a plurality of relaying devices each configured to relay transmission of the collected contents provided by the content providing unit, and a terminal device connected to at least one relaying device so as to communicate therewith, the contents collected by the content collecting unit being transmitted by the content providing unit to the terminal device via the at least one relaying device. The content collecting unit collects contents in accordance with a predetermined collecting condition. Further, the content providing unit transmits the contents to the relaying devices, each content transmitted to the relaying device being relayed to the terminal device connected to the relaying device, a type of content transmitted to each relaying device being determined in accordance with a location of the relaying device.

According to the above configuration, the contents collected by the information collecting device can be transmitted to the relaying devices in accordance with the locations thereof. Then, the contents are relayed to the terminal devices respectively connected to the relaying devices.

As above, the information collecting device transmits the contents to the relaying devices, which relay the received contents to the terminal devices. Therefor, if the terminal device that receives a certain content is to be replaced with another terminal device, what is necessary is to connect the other terminal device to the relaying device so that the communication can be performed therebetween. It should be noted that no other particular setting is necessary, and the content can be transmitted to the intended terminal device.

Further, according to the above configuration, since the types of contents provided to the relaying devices depend on the locations of the relaying devices, it may be possible to restrict the type of the contents to be provided to each relaying device (and therefore, to each terminal device).

It should be noted that the “type of contents” may be information (e.g., keywords) to be referred to when the content collecting unit collects the contents, categories extracted from or determined based on the collected contents. It is noted that the “type of contents” need not be limited to those indicated above and/or described in the specification. Any kind of distinction may be used to categorize the type of the contents.

The information collecting device may include a relaying device identifying unit that identifies a relaying unit corresponding to a type of the collected content based on correspondence information representing a relationship between a location of each relaying device and a type of content to be provided to the terminal device corresponding to the relaying device. Further, the content providing unit may transmit the content collected by the content collecting unit to the terminal device via the relaying device which is identified by the relaying device identifying unit.

One of the plurality of relaying devices may be configured to relay transmission of the content to a first terminal device and a second terminal device. The first terminal device may include a notifying unit that notifies that the content is provided from the information collecting device via the relaying device. The second terminal device may include a reproducing unit that reproduced the content provided from the information collecting device via the relaying device.

The first terminal device may have a function of relaying the transmission of the content from the relaying device to the second terminal device at a level of a data link layer level of Open System Interconnection's reference model.

At least one of the terminal devices to which the content can be provided through the relaying device may retain content type information indicating a type of content to be reproduced by the terminal device. The information collecting device may include a type collecting unit that collects the content type information from the terminal devices through the respective relaying devices, and the content providing unit transmits the content of the type indicated by the content type information prior to contents of other types.

The content collecting unit may be configured to collect contents suitable to locations where the relaying devices are provided.

According to aspects of the invention, there is provided an information collecting device configured to collect various types of contents and to provide the collected contents to terminal devices. The information collecting device may include a content collecting unit configured to collect the contents in accordance with a predetermined collecting condition; and a content providing unit configured to provide the contents to the relaying devices, each content transmitted to the relaying device being relayed to the terminal device connected to the relaying device, a type of content transmitted to each relaying device being determined in accordance with a location of the relaying device.

According to aspects of the invention, there is provided a computer program product comprising a computer readable instructions that cause a computer to function as an information collecting device configured to collect various types of contents and to provide the collected contents to terminal devices via relaying devices, respectively. The instructions cause the computer to collect the contents in accordance with a predetermined collecting condition, and to provide the contents to the relaying devices, each content transmitted to the relaying device being relayed to the terminal device connected to the relaying device, a type of content transmitted to each relaying device being determined in accordance with a location of the relaying device.

According to aspects of the invention, there is provided a content providing system, which is provided with an information collecting device including a content collecting unit and a content providing unit, a plurality of relaying devices each configured to relay transmission of the collected contents provided by the content providing unit, and a terminal device connected to at least one relaying device so as to communicate therewith, the contents collected by the content collecting unit being transmitted by the content providing unit to the terminal device via the at least one relaying device. The content collecting unit collects contents in accordance with a predetermined collecting condition. Further, the content providing unit transmits the contents to the relaying devices, each content transmitted to the relaying device being relayed to the terminal device connected to the relaying device, a type of content transmitted to each relaying device being determined in accordance with a characteristic of the relaying device.

### EMBODIMENTS

Referring to the accompanying drawings, aspects of the invention will be described in detail.

### First Embodiment

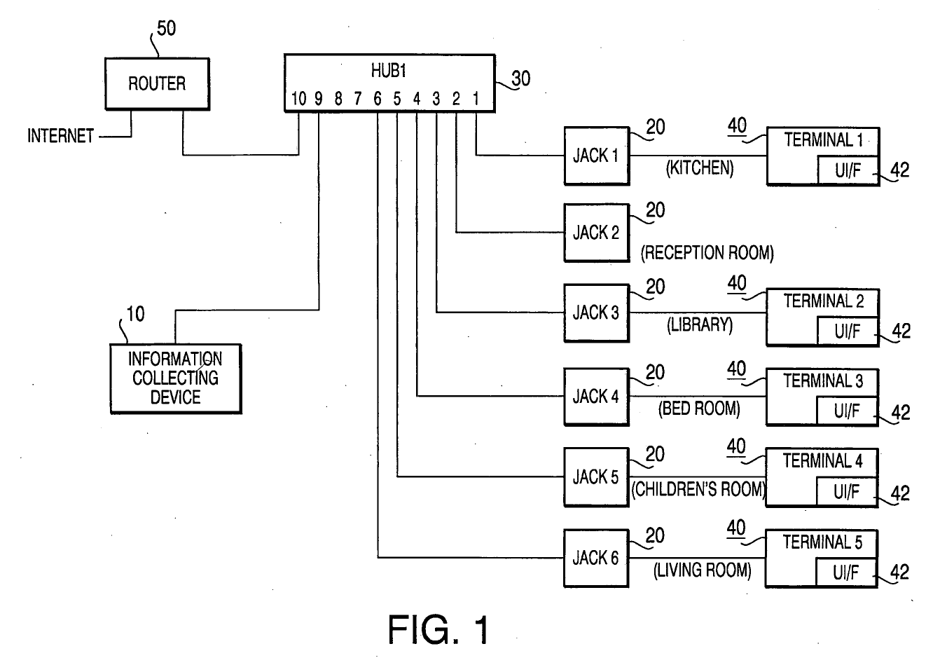

FIG. 1 is a block diagram showing a configuration of a content providing system 1000 according to aspects of a first embodiment of the invention.

As shown in FIG. 1, the content providing system 1000 includes an information collecting device 10 and a plurality of jacks 20 which are connected via a HUB 30 so that data communication can be performed therebetween. The information collecting device 10, the HUB 30 and the plurality of jacks 20 constitute a LAN (Local Area Network). Further, to the plurality of jacks 20, a plurality of terminal device 40 are connected, respectively. It is noted that this network is connected to an external network (which is the Internet, according to the embodiment) via a router 50 connected to the HUB 30.

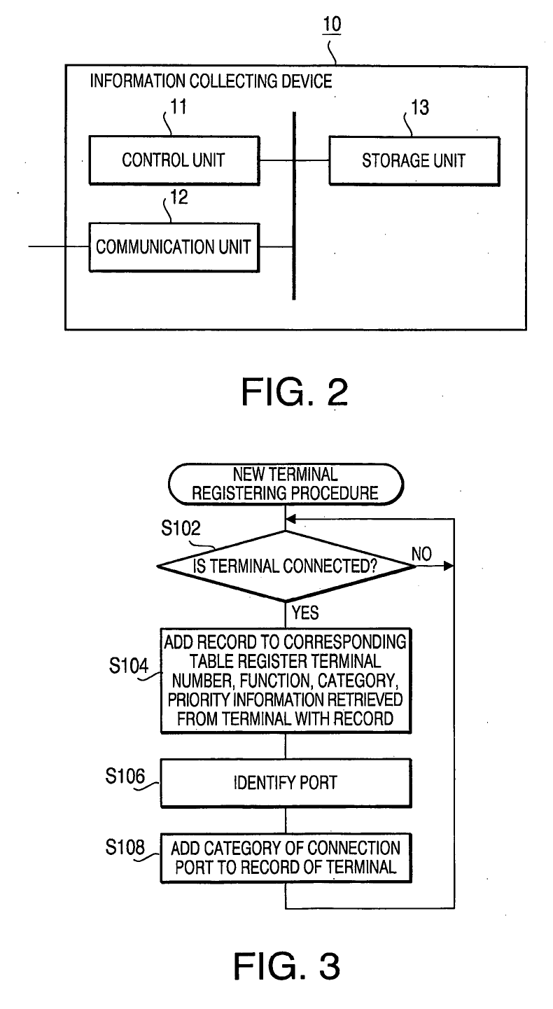

FIG. 2 is a block diagram showing a configuration of the information collecting device 10 according to aspects of the first embodiment of the invention. As shown in FIG. 2, the information collecting device 10 includes a control unit 11 that controls the entire operation of the information collecting device 10, a communication unit 12 that controls a connection between the information collecting device 10 and the network, and a storage unit 13 that stores various pieces of data.

The plurality of jacks 20 includes a plurality of connectors located at different places. By connecting the connector of the terminal device 40, the terminal device 40 can communicate with the information collecting device 10 via the jack 20 and the HUB 30, as shown in FIG. 1.

Each terminal device 40 is provided with a user interface (UI/F) 42 which includes a display unit for displaying various pieces of information, a sound output unit that outputs sound/audio information.

Next, various procedures executed by the control unit 11 of the information collecting device 10 will be described.

FIG. 3 is a flowchart illustrating a new terminal registration procedure according to aspects of the invention.

When the new terminal registration procedure is started, the process pauses (S102: NO) until a new terminal device 40 is connected to the jack 20. According to the first embodiment, the terminal device 40 is configured such that, when the terminal device 40 is connected to the network, a notification indicating the connection to the network is transmitted to the network. Therefore, in S102, when the process (i.e., the control unit 11) receives the notification via the network (HUB 30), the process determines that the new terminal device 40 is connected to the jack 20. It should be noted that the notification from the terminal device 40 is information which is stored in the storage unit of the respective terminal devices 40.

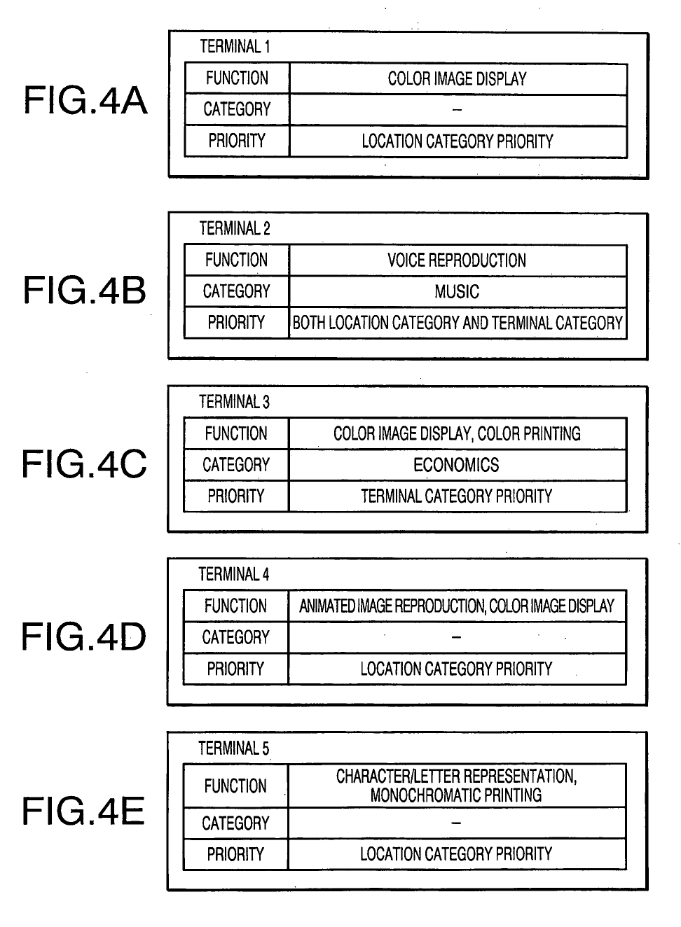

FIGS. 4A-4E show examples of data structures of the terminal devices 40 according to aspects of the first embodiment. As shown in the drawings, terminal information including information of the function (e.g., the reproduction function: the function to reproduce the sound data included in the content), the category (e.g., the content to be reproduced by the terminal device 40), and priority indicating that which one of the contents should be reproduced prior to the other are transmitted together with the notification.

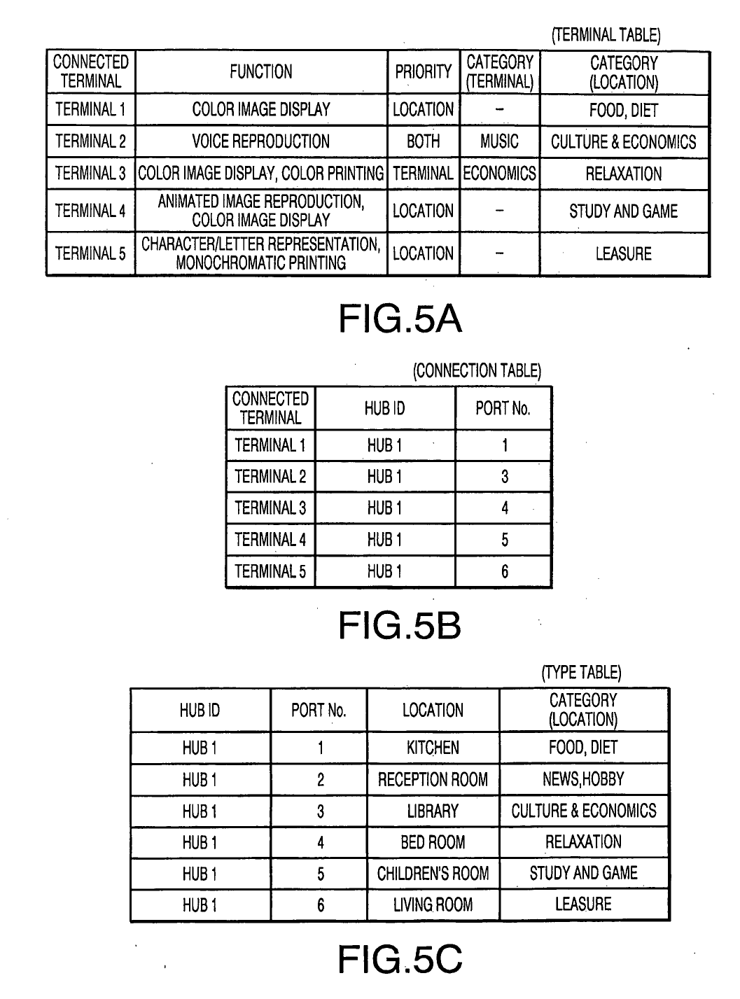

If the process judges that the new terminal device 40 is connected to the jack 20 (S102: YES), the process adds a new record to the terminal table, and registers the information regarding the new terminal device 40 with the record (S1104). The data structure of the “terminal table” is shown in FIG. 5A. As shown, the terminal table stores, for each terminal device 40 that can communicate with the information collecting device 10, identification information of the terminal device 40 (an item of “connected terminal”), the reproducing function of the terminal device 40 (an item of “function”), the type of content which should be reproduced prior to the other (an time of “priority”), the type of the contents to be reproduced by the terminal device 40 (an item of “category (terminal)”), the type of the content that is suitable to the location of the jack 20 to which the terminal device 40 is connected (an item of “category (location)”) are stored in a related manner.

In S104, the process registers the identification information (terminal n) of the terminal device 40 with the “connected terminal”, the reproduction function included in the terminal information received in S102 with the “function”, the priority order included in the terminal information with the “priority”, and the type included in the terminal information with the “category (terminal)”.

Next, the process judges through which port of the HUB 30 the terminal device 40 is connected to the jack 20 (S106). According to the first embodiment, the HUB 30 is configured to store a connection table, as shown in FIG. 5B, in the built-in memory, and updates the same. The connection table is a data table storing relationship between the ports (1-10) of the HUB 30 and terminal devices 40 connected thereto.

In S106, the process requests the HUB 30 for the connection table using a network management protocol such as the well-known SNMP (Simple Network Management Protocol). Then, the process identify the port corresponding to the identification information of the newly connected terminal device 40 from among the ports registered with the connection table. It should be noted that, in the above-described connection table, not only the relationship between the ports and the terminal devices 40, but the relationship among the ports, information collecting devices 10 and routers is also registered. However, in FIG. 5B, such relationship is omitted for the brevity.

Next, for the jack 20 which is connected with the terminal device 40 through the port identified in S106, the process identifies the type of the content suitable to the location of the jack 20 based on the category table, and registers (S108) the thus identified type of the contents with the record added to the terminal table in S104. Then, the process returns to S102.

An example of the “category table” is shown in FIG. 5C. As shown in FIG. 5C, the category stores, for each port of the HUB 39, the location of the jack 20 connected via the HUB 30 (location), types of content suitable to the location (category (location)) are stored in relation to each other.

The process identifies the “category (location)” corresponding to the port identified in S106 among the registered “category (location)” in the category table. Then, the thus identified “category (location)” with the record added in S104.

The terminal table is created such that, for all the ports of the HUB 30 connected with the jacks 20, the types of content to be reproduced at the location of the jacks are registered by the user as the contents suitable to be reproduced by the corresponding jacks 20.

By executing S104-S108, information regarding the newly connected terminal device 40, and the type of contents suitable to the location of the jack 20 that is connected to the terminal device 40 are registered with the new record in the terminal table.

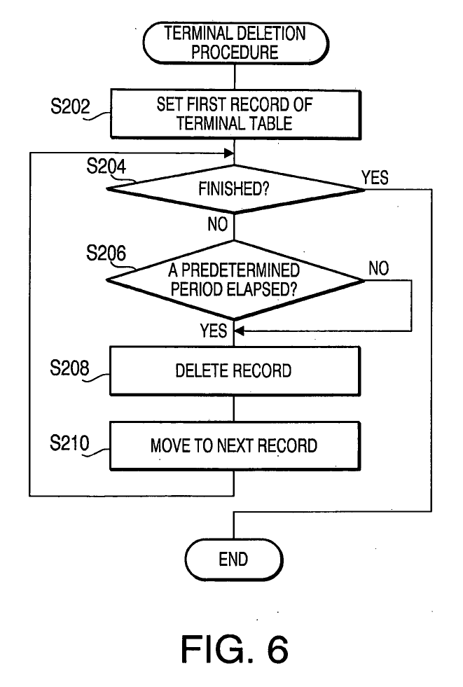

Next, the terminal deletion procedure, which is repeatedly executed at every predetermined interval (five minutes, in the first embodiment) after the information collecting device 10 is started, will be described with reference to FIG. 6.

When the terminal deletion procedure is started, from among the records in the terminal table, the process sets the firstly registered record as a processing target (S202).

Then, the process judges whether the following steps have been executed for all the records in the terminal table, or there was no record to be set as the processing target in the previous steps (S202, S210) in S204.

If the process determines that the processing of all the records has not been finished (S204: NO), the process judges whether a predetermined period (48 hours in the present embodiment) or more has elapsed after the communication with the terminal device 40, which is identified by the “connection terminal” of the record subjected to be processed, has been executed finally (S206).

If the process determines that the predetermined period has elapsed (S206: YES), the process deletes the target record from the terminal table (S208). Then, the process sets the second oldest record as the process target (S210) and returns to S204.

If the process determines that the predetermined period has not yet elapsed (S206: NO), then the process does not execute S208 and proceeds to S210, where the next record is set as the process target. Thereafter, the process returns to S4.

After S204 through S210 are repeated, and the process determines that all the records have been processed or there is no record to be processed (S204: YES), the process finishes the terminal deletion procedure.

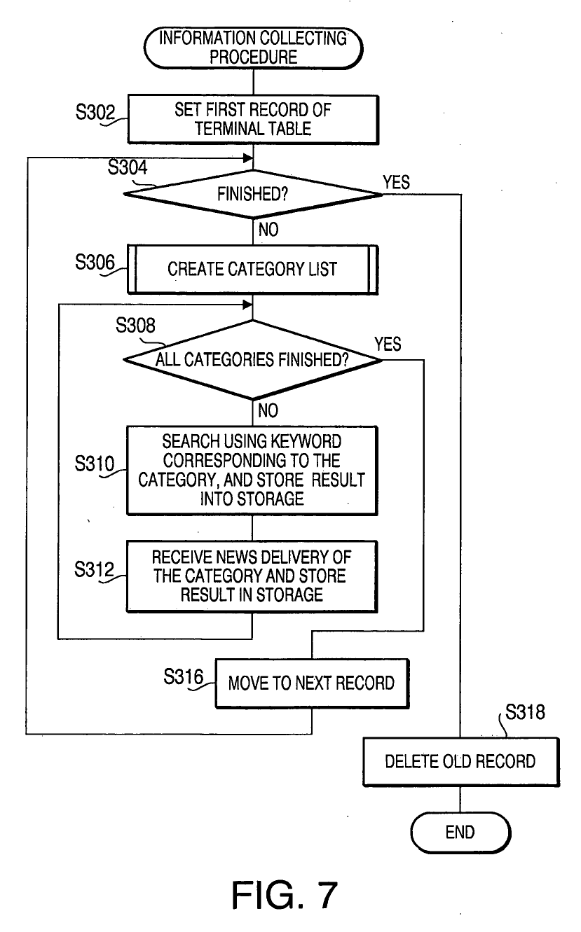

Next, an information collecting procedure which is repeated at every predetermined period (one minute in the first embodiment) after the information collecting device 10 is started up will be described with reference to FIG. 7.

When the information collecting procedure is executed, the process firstly sets the firstly registered record (i.e., the oldest record) among the records in the terminal table as a process target in the following steps (S304-S316) in S302.

Next, the process judges whether the following steps have been done for all the records in the terminal table, or there is not record to be set as the process target in the previous steps (S302, S316) (i.e., no record has been registered in the terminal table) in S304.

If the process determines that all the records have not yet been processed (S304: NO), the process creates a category list based on the records subjected to be processed (which will be referred to as target records) in S306. Specifically, by executing the category list creating procedure (which will be described later) based on the process target records, the category list which is a data table storing the type of contents to be reproduced by the terminal devices identified by the “connect terminal” of the target record and/or type of contents suitable to the location of the jack 20 connected to the terminal devices,

Next, the process judges whether the following steps (S308-S312) have been finished with respect to all the contents types (categories) registered with the category list created in S306, or whether there is no type is included in the category list (S308).

Then, the process judges whether the steps S308-S312 have been performed for all the content types (categories) registered with the category list, or whether the types of contents are registered with the category list (S308).

If the process for all the types of the contents have not been finished (S308: NO), based on one of content type which has not been processed (which will be referred to as target type), using a keyword corresponding to the target type, a content search is executed. Then, searched content is stored in the storage unit 13 such that the contents are related to the target types, respectively (S310).

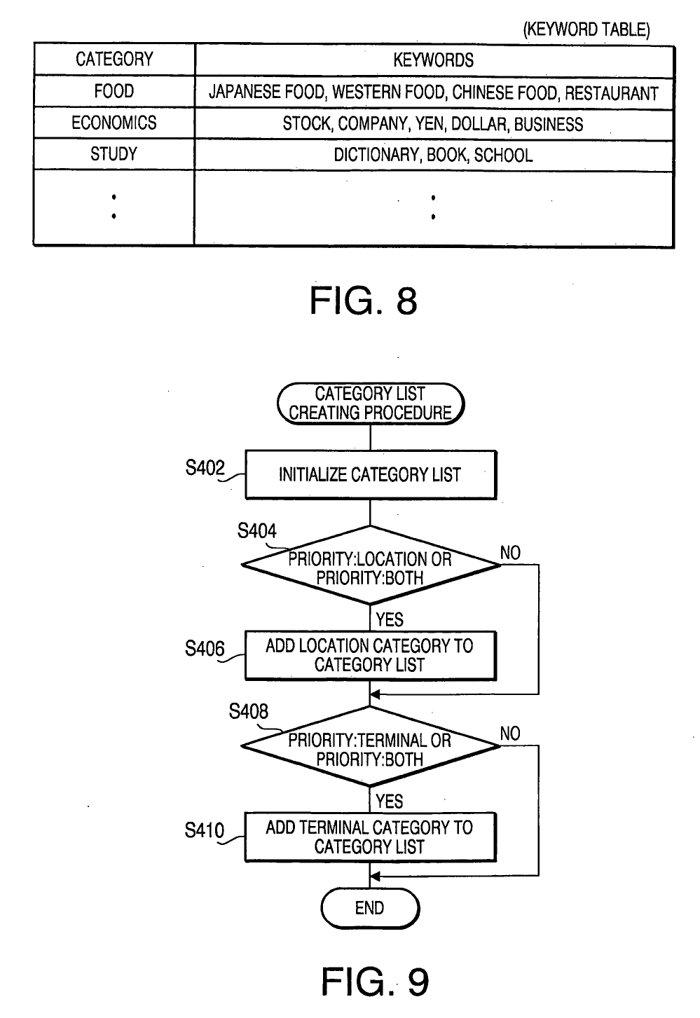

Specifically, the process extracts keywords registered in relation to the target types (categories) from the keyword table, which is a data table storing keywords corresponding to content types (see FIG. 8). The, the process transmits a command requesting a server that searches for contents based on the keywords (not shown: such a server is known on the Internet) to search for contents based on the extracted keywords, respectively. Then, the process receives the searched contents from the server. Then, the searched contents are stored in a predetermined storage area of the storage unit 13 in relation to the target types.

Next, the process receives a news delivery corresponding to the target types, and store the thus received contents in the storage unit 13 in a related fashion (S312). Specifically, the process transmits a command requesting delivery of the news contents based on the target types to the server that delivers a contents related to the news based on the contents types (hereinafter, referred to as the news contents). Then, the process receives the news contents transmitted by the server. Then, the new contents are stored in a predetermined storing area of the storage device 13 in relation to the target types.

After the contents are stored in S310 and S312, the process returns to S308, and then repeats S308-S312 so that the contents are collected for all the types of contents registered with the category list.

Thereafter, steps S310-S312 for all the content types are processed, or the process determines that the contents type is not included in the category list generated in S306 (S308: YES), a succeeding record in the terminal table of the current target record (i.e., the second oldest record) is set to the next target record with respect to steps S306-S316, and the process returns to S304.

Then, S304 through S316 are repeated. When the process determines that all the records have been processed or no record to be processed exists (S304: YES), the process deletes the content which has been stored in the storage unit 13 for a predetermined period (72 hours in the embodiment) or more (S318), and the process finishes the information collecting procedure.

As above, in the information collecting procedure, the content to be reproduced by the terminal device 40 identified by the “connected terminal” of each record of the terminal table, and the content suitable to the location of the jack 20 to which the terminal device 40 is connected are collected.

Next, the category list creating procedure which is called in S306 of FIG. 7 will be described with reference to the flowchart show in FIG. 9.

When the category list creating procedure is started, the process initializes a category list (i.e., delete all the registered information) in S402.

Next, among the target records (the records of the terminal table and are set as process targets), information having the “priority” are detected (S404). If the information is “location” or “both” (S404: YES), the information (category) registered with the “category (location)” is registered with the category list (S406), and the process proceeds to the next step (S408). If the information is “terminal” (S404: NO), the process sips S406 and proceeds to S408. In the “category (location)” of the terminal table, the content type suitable to the location of the jack 20, which is connected with the terminal device 40 identified by the “connected terminal” of the record (S108 of FIG. 3). It should be noted that to register the registration information of “category (location)” of the target record with the category list is to register the content type suitable to the location of the jack 20 to which the terminal device 40 is connected with the category list.

In S408, the process checks the information registered with the item of “priority” among the records set as process targets, and if the information is “terminal” or “both” (S408: YES), the information (category) registered with the “category (terminal)” of the same record is registered with the category list (S410), and the process finishes the category list creating procedure. Thereafter, the process proceeds to S308 of FIG. 7.

If the information registered with the item of “priority” is “location” (S408: NO), the process does not execute S410, and finishes the category list creating procedure. Thereafter, the process proceeds to S308. The “category (terminal)” of the terminal table stores the content type to be reproduced by the terminal device 40 identified by the “connected terminal” of the record (see S104 of FIG. 3). It should be noted that to register the information stored in the “category (terminal)” of the target record with the category list is to register the content type to be reproduced by the terminal device 40 with the category list.

Next, the information delivery procedure which is repeated at ever predetermined period (10 minutes, according to the first embodiment) after the information collecting device 10 is started up.

When the information delivery procedure is started, firstly, the process sets, among records of the terminal table, one registered first (i.e., the oldest record) as the process target (S502).

Then, the process judges whether all the records of the terminal table have been processed or there were no records to be set as the process target in the previous steps (i.e., no records have been registered with the terminal table) (S502, S514) in S504.

If the process determines that all the records have not been processed (S504: NO), the process creates a category list based on the target records (S506). Specifically, the process creates the category list by executing the category list creating procedure based on the target records.

In S310 and S312, the process identifies the contents related to the types of the target (i.e., category) that matches the registered type (category) in the category list created in S506. Then, from the contents thus identified, the latest ones (i.e., one stored lastly) are selected and a predetermined number of contents are selected (S508).

Since the category list includes the types of contents to be reproduced by the terminal device 40 identified by the “connected terminal” of the target record and/or the types of contents suitable to the location of the jack to which the terminal device 40 is connected. Therefore, the content selected in S508 is the content of a type to be reproduced by the terminal device 40 or the content suitable to the location of the jack 20 to which the terminal device 40 is connected.

Next, the process judges whether the content selected in S508 can be reproduced by the terminal device indicated by the “connected terminal” of the target record (S510). Specifically, if the a function necessary for reproducing the contents selected in S508 is registered as the “function” of the target record, the process determines that the terminal device 40 can reproduce the content. More specifically, if the content is composed of color image data, when a “color image display” or “color print” is registered as the “function”, the process determines that the content can be reproduced. If the content is composed of sound data, when the “sound reproduction” is registered as the “function”, the process determines that the content can be reproduced. If the content is composed of text data, the process determines that the content is reproducible if the “text display” or the like is registered as the “function”. If the content is composed of the “animated image data”, the process determines that the content can be reproduced when the “animated image reproduction” is registered as the “function. If the content is composed of monochromatic image data, the process determines that the content can be reproduced when the “monochromatic image print” or the like is registered as the “function”.

If the process determines that the content can be reproduced (S510: YES), the process transmits the content to the terminal device 40 identified by the “connected terminal” of the target record (S512), and the process proceeds to S514. In S512, the process identifies the port number corresponding to the “connected terminal” of the target record from among the port numbers of the HUB 30 registered with the connection table. Then, by transmitting the content using the port number, the process transmits the content to the terminal device 40 identified by the “connected terminal” of the target record. As above, the content to be reproduced by the terminal device 40 identified by the “connected terminal” of the target record can be transmitted, or the content suitable to the location of the jack 20 to which the terminal device 40 is connected can be transmitted.

If the process determines that the content cannot be reproduced by the terminal device 40 (S510: NO), the process does not transmit the content in S512, and proceeds to S514.

The process sets the next oldest record (which is the oldest than any other records except the target record) is set to the next process target (S514) of the succeeding steps (S504-S514), and the process returns to S504.

After execution of S504-S514, if the process determines that all the records have been processed or there is no record to be set as the process target (S504: YES), the process finishes the information delivery procedure.

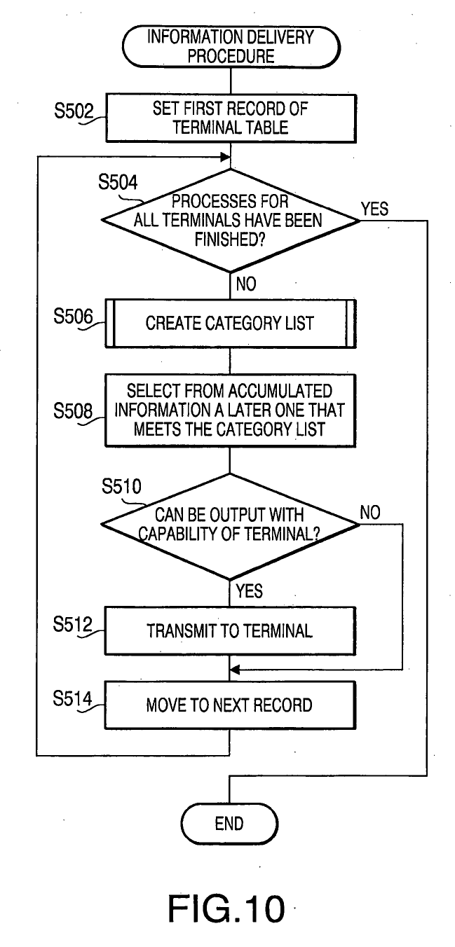

According to the content providing system described above, the content collected by the information collecting device 10 is transmitted to the jack 20 (and the connected port of the HUB 30) which is provided at a location appropriate to the type of the content (S512 of FIG. 10). Therefore, the content can be provided to the terminal device 40 which is connected to the jack 20 so as to communicate with the terminal device 40.

As above, the information collecting device 10 transmits the content to the jack 20 provided at a location corresponding to the type of the content, and the content is provided to the terminal device 40 through the jack 20. Therefore, when the terminal device 40 which is to received the content is to be changed to another terminal device 40, only by connecting the terminal device 40 to an appropriate jack 20, the content can be provided to the desired terminal device 40.

According to the content providing system, the content collected by the information collecting device 10 is transmitted to the jack 20 provided at a location corresponding to the type of the content. Therefore, at each location of the jack 20, the type of the contents which can be provided to the terminal device 40 (and thus, to the user of the terminal device 40) can be restricted.

The “terminal table” stores the ports of the HUB 30 and the type of contents suitable to the locations of the jacks 20 in a related manner. Therefore, as the user arbitrarily updates or modify the registered data of the terminal table, the type of the contents to be provided to the terminal device 40 at each location of the jack 20 can be restricted as the user intends.

The information collecting device 10 registers configuration information of the terminal device obtained from each terminal device 40 with the terminal table (S104 of FIG. 3), creates the category list corresponding to the registered data (S506 of FIG. 10), and then selects the content to be provided based on the category list (S508 of FIG. 10). If the “priority” of the target record is “terminal” or “both”, what is registered with the category list is the registered information of “category (terminal)” of the table (S410 of FIG. 9). It should be noted that the “category (terminal)” is the registered information of “the type of the contents which can be reproduced by the terminal device 40” (S104 of FIG. 3).

When the contents are provided through the HUB 30 and the jack 20, if the “type (the type of contents subject to priority reproduction)” configuring the terminal information collected from the terminal device 40 connected to the jack 20 is “terminal” or “both”, the content of “the type of content to be reproduced by the terminal device 40” configuring the terminal information can be transmitted prior to the other information.

Therefore, not only the location of the jack 20 but the terminal device 40 connected to the jack 20 can be taken into account when the content is transmitted to the terminal device 40 via the jack 20 and HUB 30.

In the first embodiment, the information collecting device 10 creates the category list before it collects the content (S306 of FIG. 7). Then, based on the registered data of the category list, the contents are collected (S308-S312 of FIG. 7). In the category list, the type of contents to be reproduced by the terminal device 40 which is identified by the “connected terminal” of each record in the terminal table, and the type of the contents suitable to the location of the jack 20 to which the terminal device 40 is connected are registered (FIG. 9). Because of the above configuration, the contents collected above do not include ones which are suitable to the locations of the jacks 20 to which the terminal devices 40 are not connected. To collect such a content is inappropriate since such a content will not be provided to a terminal device 40, and requires certain processing to collect and store the same, which requires the information collecting device 10 the unnecessary processing. Therefore, according to the above embodiment, such content will not be collected (i.e., unnecessary contents will not be collected/stored), which reduces the processing burden to the information collecting device 10.

### Second Embodiment

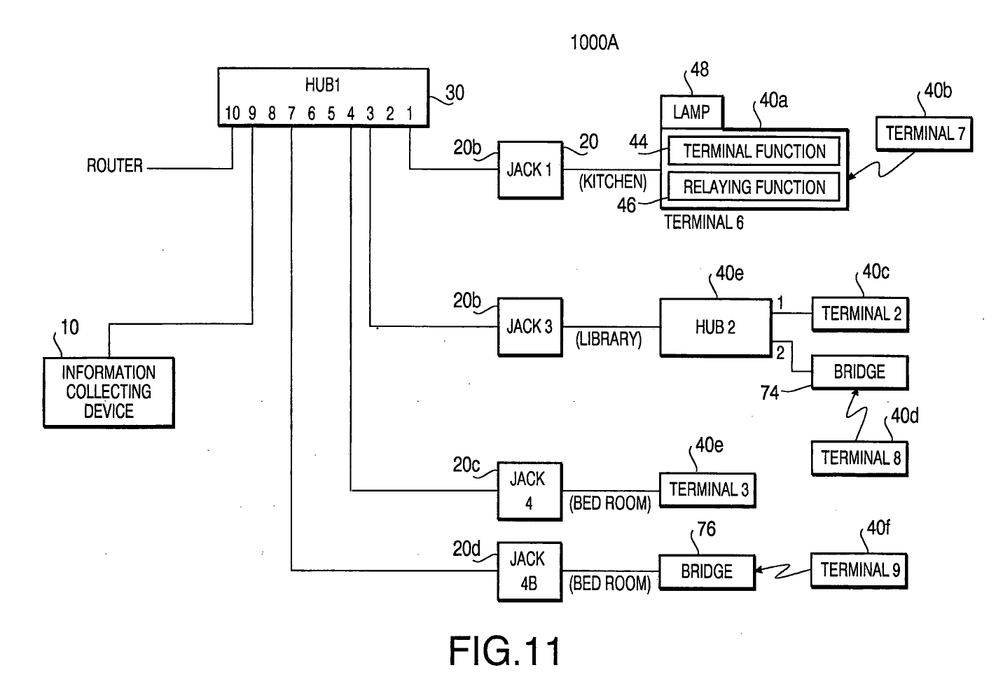

FIG. 11 is a block diagram of a content providing system 1000A according to aspects of a second embodiment.

In the first embodiment, only one terminal device 40 is connected to the information collecting device 10 through a single port of the HUB 30. According to a second embodiment, a plurality of terminal devices 40 can be connected through a single port of the HUB 30 as shown in FIG. 11.

As shown in FIG. 11, to the jack 20a connected to the first port of the HUB 30, a relaying terminal device 40a is connected. The relaying terminal device 40a includes a terminal function 44 and a relaying function 46 that relays a communication between the information collection device 10 and another terminal device 40 with a radio signal. By the relaying function of the relaying terminal device 40a, the jack 20 a is connected with a wireless terminal device 40b such that a wireless communication can be done.

The relaying function 46 of the relaying terminal device 40a is a function of relaying the communication at a level of a data link layer in the well-known OSI (Open System Interconnection) reference model, and thus the relaying function 46 functions as bridge or repeater.

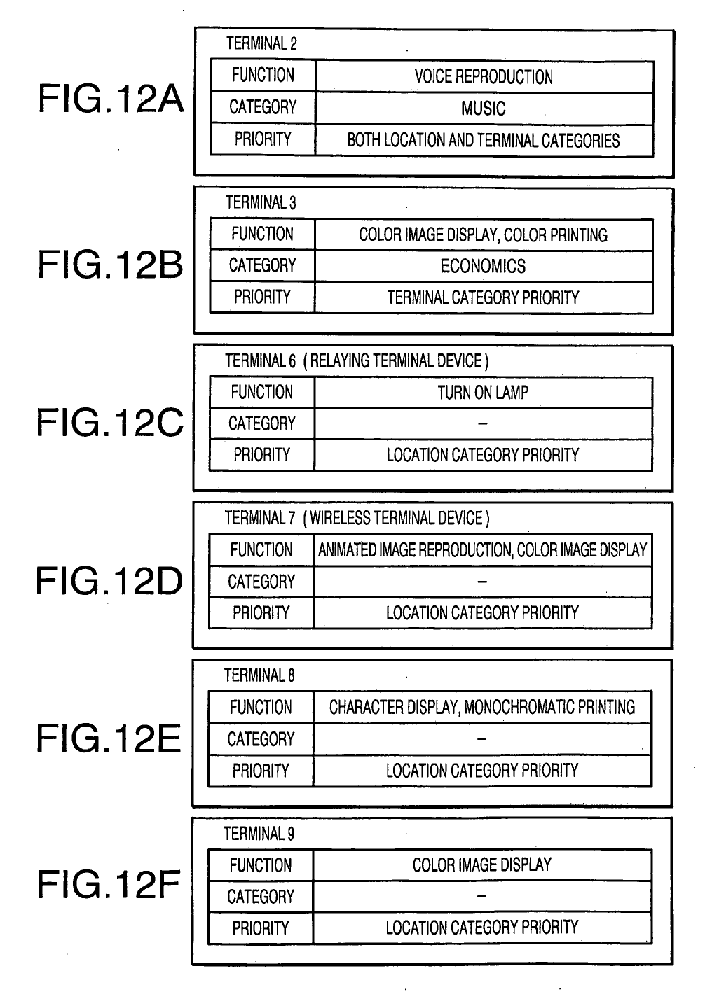

In this configuration, the relaying terminal 40a has a function of notifying receipt of a content with a lamp 48 as a reproducing function (see FIG. 12C), while the wireless terminal device 40b has a function of reproducing various contents (see FIG. 12D).

To the jack 20b connected to the third port of the HUB 30, a terminal device 40c and a wireless bridge 74 are connected through a HUB 72. The wireless bridge 74 has a function of the relaying device 46 described above. By use of the wireless bridge 74, to the jack 20b, the wireless terminal device 40d capable of performing a wireless communication is connected. It should be noted that the terminal device 40c is the same as the terminal device 40 according to the first embodiment.

To the seventh port of the HUB 30, a jack 20d is connected. To the jack 20d, a wireless bridge 76 is connected. By the wireless bridge 76, the jack 20d is connected with a wireless terminal device 40f which can perform a wireless communication. In FIG. 11, the jack 20c is connected to the fourth port of the HUB 30. This connection is similar to that shown in the first embodiment, and description thereof will be omitted.

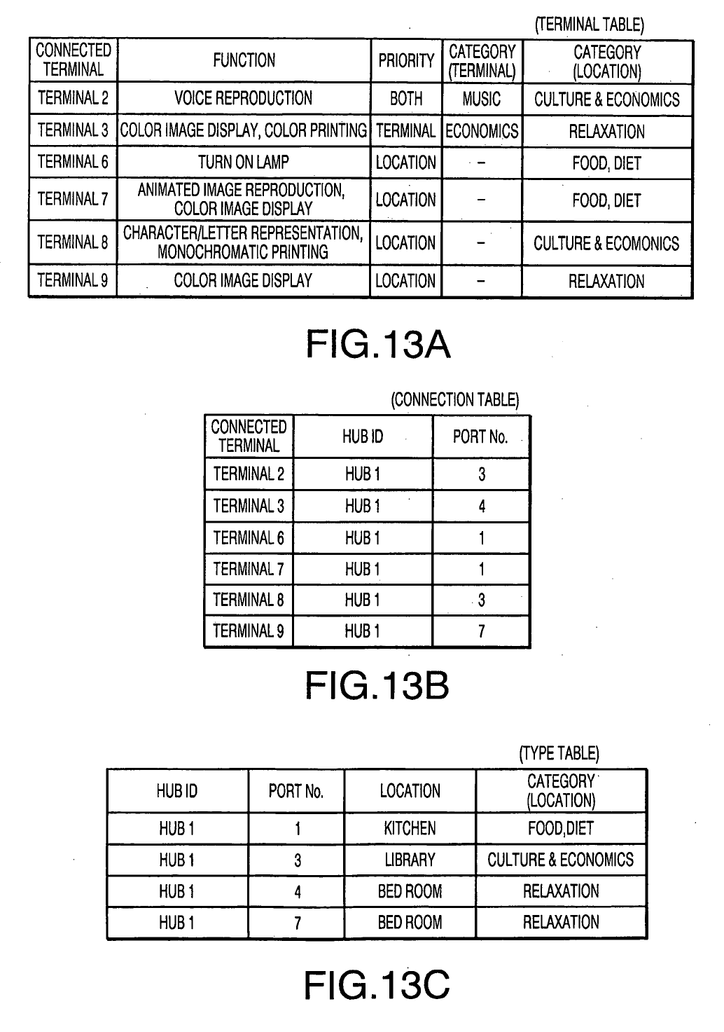

In the second embodiment, a new terminal registering procedure, a terminal deleting procedure, an information collecting procedure and a category list creating procedure are similar to those shown in FIGS. 3, 6, 7 and 9, respectively. It should be noted, however, in the new terminal registering procedure, the terminal information shown in FIGS. 12A-12F, the connection table shown in FIG. 13B, the terminal table shown in FIG. 13C are used and registration with the terminal table shown in FIG. 13A is executed.

Regarding the information delivery procedure (FIG. 10), when the process judges whether the content can be reproduced by the terminal device 40 identified by the “connected terminal” of the target record (S510), and if the function necessary for reproducing the content selected in S508 is registered as the “function” of the target record, the process determines that the content can be reproduced, which is principally the same as the first embodiment.

In this case, the information collecting device 10 outputs a content to be transmitted to the terminal function 44 (i.e., a content for turning on the lamp 48 to indicate that a content is provided), and a content to be transmitted to the wireless terminal device 40b (i.e., a content which can be output in accordance with the “function” of the wireless terminal device 40b). The relaying terminal device 40a notifies that the content (which indicates that the content will be provided) will be provided in accordance with the content transmitted in S512. The information collecting device 10 also provides, via the relaying terminal device 40a, the contents which can be output by the wireless terminal device 40b. Thus, the wireless terminal device 40b reproduces the content received from the information collecting device 10.

Thus, in the second embodiment, the relaying terminal device 40a and the wireless terminal device 40b are different only in their “functions”, and the locations and terminal information are substantially the same. Accordingly, by the relaying terminal device 40a, a condition where the contents can be provided, and by the wireless terminal device 40b, the content can be reproduced.

According to the second embodiment of the content providing system, the same effects can be obtained from the configuration similar to the first embodiment. In addition, the following effects can be obtained based on the configuration of the second embodiment.

When the content is provided from the information collecting device 10 via the jack 20a connected to the first port of the HUB 30, an notification indicating that the contents is provided may be notified to the lamp 48 of the relaying terminal device 40a, and the content may be reproduced by the wireless terminal device 40b.

According to such a configuration, it is possible to employ an inexpensive terminal device which does not have a function to reproduce the content as the relaying terminal device. Therefore, for example, when the jack 20 is located at a relatively wide area, only one expensive wireless terminal device 40b having a function of reproducing the contents may be provided, and as other devices, a plurality of inexpensive relaying terminal devices 40a may be employed. With such a configuration, even though the user is remote from the wireless terminal device 40b, the user can know that the content is provided and reproduced by the relaying terminal device 40a by the notification of the relaying terminal device 40. After such notification, when the user sees the wireless terminal device 40b, the user may receive the content.

The system may be configured such that, at an initial stage, the system may consists of only relaying terminal devices 40a, and after the notification is made by the relaying terminal device 40a, if the user adds the wireless terminal device 40b to the system, the user can receive the content through the wireless terminal device 40b. With this configuration, if a plurality of jacks 20 are provided at a plurality of locations by only a single wireless terminal device 40b is available, by moving the wireless terminal device 40b to the jack 20 at which the notification is made by the replaying terminal device 40a connected to the jack 20 and connecting the wireless terminal device 40b to the jack 20, the user can receive the content at any one of the jack 20.

The relaying terminal device 40a is configured to relay the communication of the wireless terminal device 40b by the relaying function 44 at a level of the data link layer. Therefore, the relaying terminal device 40a does not actively establish a communication with the wireless terminal device 40b to transmit data (including the contents). Since the burden to such processing is suppressed, the manufacturing cost of the relaying terminal device 40a can be well suppressed. Further, the contents the wireless terminal device 40b receives is directly received from the information collecting device 10, it is unnecessary for the relaying terminal device 40a to store the contents the wireless terminal device 40b should receive.

It is possible to provide a plurality of terminals 2 (terminals 8, terminals 3 and terminals 9) in one room, and the function, priority of types of contents (category (terminal), category (location)) in providing the contents can be set individually. Therefore, different types of information can be provided at different terminals. For example, at the terminal 2, the reproduction of sound data related to music, literature or economics may be done, while at the terminal 8, the text indication or the monochromatic printing of cultural information, economical information may be done.

It should be noted that the present invention need not be limited in the above-described illustrative embodiments, and various modification may be made without departing aspects of the invention.

For example, in the above-described embodiments, the information collecting device 10 is configured such that the collected contents are stored the “type” used for searching the contents are also stored in relation to the contents. It should be modified such that other information may be stored instead of the “type” of the contents. For example, information extracted from the collected contents may be stored as the type of the contents.

In the above-described embodiments, the information collecting device 10 obtains terminal information which is transmitted by the terminal device 40 when it is connected to the network. It is possible to employ another configuration to obtain the terminal information. For example, if the terminal device 40 is configured not to actively transmit the terminal information, the procedure shown in FIG. 3 may be modified such that a request for the terminal information is transmitted to the terminal device 40 before S104, and based on the response to the request, the terminal information is obtained.

In the above-described embodiments, the information collecting device 10 register the configuration information of the terminal information obtained from the terminal device 40 with the terminal table (S104), and then creates the category list based on the registered data (S506 of FIG. 10). Then, the information collecting device 10 selects the content to be provided (S508).

When the “priority” of the terminal table is “terminal”, the registered data of the “category (terminal)” is registered with the category list (S410 of FIG. 9). Then, based only on the registered data, the content is selected and transmitted (S508, S12 of FIG. 10). The “category (terminal)” represents the type of the content to be reproduced by the terminal device 40 of the terminal information (S104 of FIG. 3). Therefore, regardless whether the type is suitable to the location of the jack 20, he contents of the “type” configuring the terminal information is transmitted.

As above, according to the embodiments, if the “type” of the terminal information is the “terminal”, by sending only the type of the contents, priority transmission of the “type” configuring the terminal information is achieved. It should be noted, however, the priority transmission of the contents of the “type” configuring the terminal information may be achieved in various ways.

In the above-described embodiments, the information collecting procedure shown in FIG. 7 may be modified as follows. That is, the process may check whether the communication with the terminal device 40 can be done via the HUB 30 and the jack 20. If the communication can be done, the process executes the category list creating procedure, otherwise the process proceeds to S316.

In the second embodiment, only the “function” of the relaying terminal device 40a and that of the wireless terminal device 40b, while the location and the terminal device information are the same.

However, the terminal information may not be made identical in advance. That is, when the wireless terminal device 40b is connected to the network via the relaying terminal device 40a, the terminal information thereof is synchronized with the terminal information of the relaying terminal device 40a. For example, the information collecting device 10 may transmit registration information corresponding to the relaying terminal device 40a from the records of the terminal table, and further a command to update the terminal information based on the registration information to the wireless terminal device 40b.

In the above case, it is necessary to send the registration information and the command when the information collecting device detects that the wireless terminal device 40b is connected by the relaying function 46 of the relaying terminal device 40a. A configuration for detecting the above may be realized by obtaining the connection information from the relaying function 46 using a network protocol such as an SNMP.

What is claimed is:

1. A content providing system, comprising:
an information collecting device including a content collecting unit and a content providing unit;
a plurality of relaying devices each configured to relay transmission of the collected contents provided by the content providing unit; and
a terminal device connected to at least one relaying device so as to communicate therewith, the contents collected by the content collecting unit being transmitted by the content providing unit to the terminal device via the at least one relaying device,
wherein the content collecting unit collects contents in accordance with a predetermined collecting condition, and
wherein the content providing unit transmits the contents to the relaying devices, each content transmitted to the relaying device being relayed to the terminal device connected to the relaying device, a type of content transmitted to each relaying device being determined in accordance with a location of the relaying device.

2. The content providing system according to claim 1,
wherein the information collecting device includes a relaying device identifying unit that identifies a relaying unit corresponding to a type of the collected content based on correspondence information representing a relationship between a location of each relaying device and a type of content to be provided to the terminal device corresponding to the relaying device, and
wherein the content providing unit transmits the content collected by the content collecting unit to the terminal device via the relaying device which is identified by the relaying device identifying unit.

3. The content providing system according to claim 2,
wherein one of the plurality of relaying devices is configured to relay transmission of the content to a first terminal device and a second terminal device,
wherein the first terminal device includes a notifying unit that notifies that the content is provided from the information collecting device via the relaying device, and
wherein the second terminal device includes a reproducing unit that reproduced the content provided from the information collecting device via the relaying device.

4. The content providing system according to claim 3,
wherein the first terminal device has a function of relaying the transmission of the content from the relaying device to the second terminal device at a level of a data link layer level of Open System Interconnection's reference model.

5. The content providing system according to claim 2,
wherein at least one of the terminal devices to which the content can be provided through the relaying device retains content type information indicating a type of content to be reproduced by the terminal device,
wherein the information collecting device includes:
a type collecting unit that collects the content type information from the terminal devices through the respective relaying devices, and
wherein the content providing unit transmits the content of the type indicated by the content type information prior to contents of other types.

6. The content providing system according to claim 5,
wherein the content collecting unit collects contents suitable to locations where the relaying devices are provided.

7. The content providing system according to claim 1,
wherein one of the plurality of relaying devices is configured to relay transmission of the content to a first terminal device and a second terminal device,
wherein the first terminal device includes a notifying unit that notifies that the content is provided from the information collecting device via the relaying device, and
wherein the second terminal device includes a reproducing unit that reproduced the content provided from the information collecting device via the relaying device.

8. The content providing system according to claim 7,
wherein the first terminal device has a function of relaying the transmission of the content from the relaying device to the second terminal device at a level of a data link layer level of Open System Interconnection's reference model.

9. The content providing system according to claim 7,
wherein at least one of the terminal devices to which the content can be provided through the relaying device retains content type information indicating a type of content to be reproduced by the terminal device,
wherein the information collecting device includes:
a type collecting unit that collects the content type information from the terminal devices through the respective relaying devices, and
wherein the content providing unit transmits the content of the type indicated by the content type information prior to contents of other types.

10. The content providing system according to claim 9,
wherein the content collecting unit collects contents suitable to locations where the relaying devices are provided.

11. The content providing system according to claim 1,
wherein at least one of the terminal devices to which the content can be provided through the relaying device retains content type information indicating a type of content to be reproduced by the terminal device,
wherein the information collecting device includes:
a type collecting unit that collects the content type information from the terminal devices through the respective relaying devices, and
wherein the content providing unit transmits the content of the type indicated by the content type information prior to contents of other types.

12. The content providing system according to claim 11,
wherein the content collecting unit collects contents suitable to locations where the relaying devices are provided.

13. The content providing system according to claim 1,
wherein the content collecting unit collects contents suitable to locations where the relaying devices are provided.

14. An information collecting device configured to collect various types of contents and to provide the collected contents to terminal devices,
the information collecting device comprising:
a content collecting unit configured to collect the contents in accordance with a predetermined collecting condition; and
a content providing unit configured to provide the contents to the relaying devices, each content transmitted to the relaying device being relayed to the terminal device connected to the relaying device, a type of content transmitted to each relaying device being determined in accordance with a location of the relaying device.

15. A computer program product comprising a computer readable instructions that cause a computer to function as an information collecting device configured to collect various types of contents and to provide the collected contents to terminal devices via relaying devices, respectively,
the instructions cause the computer to:
collect the contents in accordance with a predetermined collecting condition; and
provide the contents to the relaying devices, each content transmitted to the relaying device being relayed to the terminal device connected to the relaying device, a type of content transmitted to each relaying device being determined in accordance with a location of the relaying device.

16. A content providing system, comprising:
an information collecting device including a content collecting unit and a content providing unit;
a plurality of relaying devices each configured to relay transmission of the collected contents provided by the content providing unit; and
a terminal device connected to at least one relaying device so as to communicate therewith, the contents collected by the content collecting unit being transmitted by the content providing unit to the terminal device via the at least one relaying device,
wherein the content collecting unit collects contents in accordance with a predetermined collecting condition, and
wherein the content providing unit transmits the contents to the relaying devices, each content transmitted to the relaying device being relayed to the terminal device connected to the relaying device, a type of content transmitted to each relaying device being determined in accordance with a characteristic of the relaying device.
